(19) United States
(12) Patent Application Publication
(10) Pub. No.: US 2007/0237618 A1
(43) Pub. Date: Oct. 11, 2007

(54) Disc mower trailer

(76) Inventor: Leonard E. Baird, Stilwell, OK (US)

Correspondence Address: Leonard E Baird, Rt 4, Box 2660, Stilwell, OK, 74960, US

(21) Appl. No.: 11/367,809

(22) Filed: Mar. 1, 2006

(51) Int. Cl. B60P 1/00

(52) U.S. Cl. 414/550

(57) ABSTRACT

The present invention regards a disc mower trailer for supporting a disc mower for field usage and transport. The trailer includes a trailer frame supported by transport wheels and a hitch member for attachment to a conventional three-point hitch connection on an implement. The hitch member is connected to a crossbar through a linkage assembly including upper and lower link structures defining a parallelogram structure for moving the hitch member from a lowered field-use position to a raised transport position. The trailer has been designed to be versatile and apply to most models of three-point lift type disc mowers.

### REFERENCES CITED

U.S. Patent Documents

| | | |
|---|---|---|
| 3598260 | August, 1971 | Hutson |
| 3727698 | April, 1973 | Van Selus |
| 3974880 | August, 1976 | Filan et al. |
| 4032169 | June, 1977 | Filan et al. |
| 4286918 | September, 1981 | Shannon |
| 4518046 | May, 1985 | Rettig et al. |
| 4986064 | January, 1991 | Ermacora |
| 5346019 | September, 1994 | Kinzenbaw et al. |
| 5412929 | May, 1995 | Urbain et al. |
| 6360516 B1 | March, 2002 | Harkcom et al. |
| 6758284 B2 | July, 2004 | Meyers |
| 6907719 B2 | June, 2005 | Ligouy |

### BACKGROUND OF THE INVENTION

1. Field of the invention

The present invention regards a trailer able to support most models of three-point mounted disc mowers and capable of lifting a disc mower from a field use position to a transport position.

2. Related Prior Art

Trailers of carts have been developed for attachment to implements for drawing an implement through the field in a field use position. Such carts are designed to be connected to the hitch of a tractor and often include a lift mechanism to lift the implement out of contact with the ground for transport or to facilitate maneuvering in a field. For example, U.S. Pat. No. 4,032,169 discloses an apparatus for attachment to the three-point of an implement and includes a lift mechanism for supporting the implement in an elevated position. However, this apparatus does not include means for PTO operation or the required ballasting for the offset operation required by a disc mower.

### SUMMARY OF THE INVENTION

This trailer has been designed to be easily adjusted and apply to different models and widths of mowers.

The object of this invention is the result of studying the problems in the agricultural sector and in particular, in the production of implements to cut grass or hay.

In this sector, there is the necessity to simplify the hook up and transport of disc mowers in particular.

Due to the complex nature of lift and operation of many disc mowers a simple hook up was needed.

The simple heavy duty design of this invention accomplishes many of the studies focus points:
(1) Ease of hook up
(2) Ease of undue strain on tractor three-point
(3) Easier corners in operation
(4) Easier to transport from field to field
(5) Optimum adjustment of mowing guidelines

### BRIEF DESCRIPTION OF THE DRAWINGS

FIG. 1 is a perspective view of the trailer in a working position;

FIG. 2 is a plan view of the trailer with the linkage assembly in a lowered field use position;

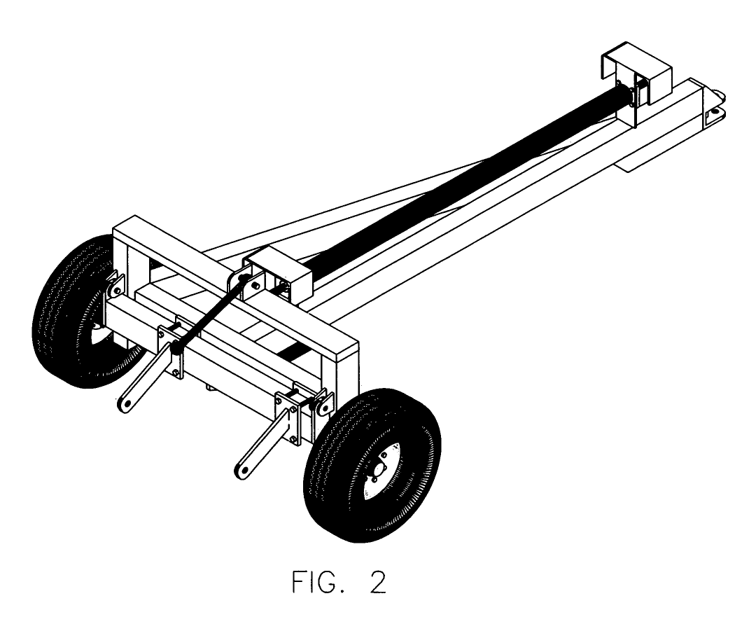

FIG. 3 is a plan view showing the rear of the trailer with the linkage assembly in a raised transport position.

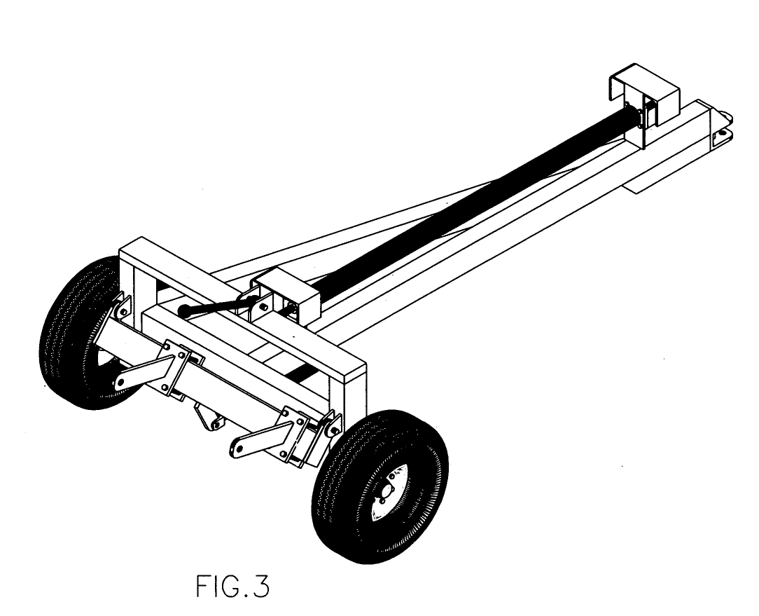

FIG. 4 is a side view showing the linkage assembly in a lowered field use position; (right wheel removed for clarity)

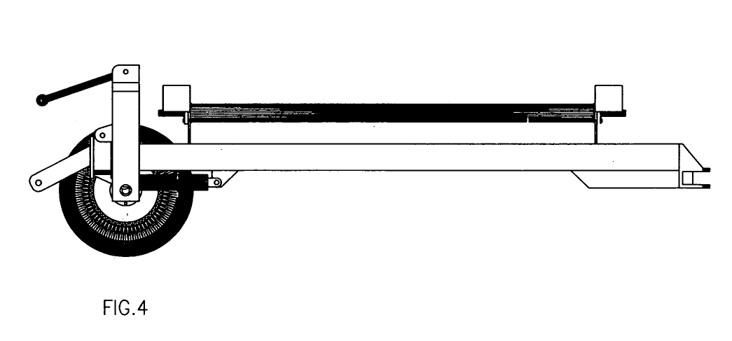

FIG. 5 is a side view showing the linkage assembly in a raised transport position; ( right wheel removed for clarity)

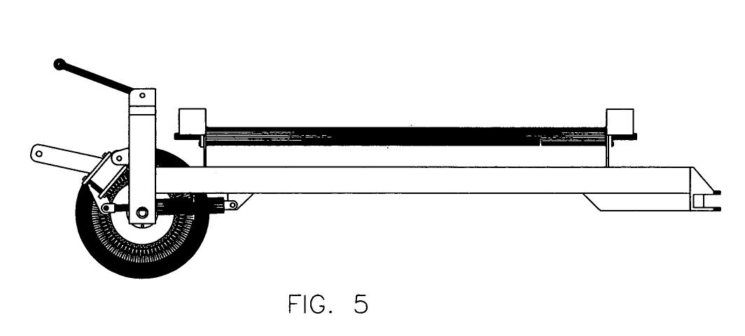

FIG. 6 is a perspective view illustrating the hitch member and attachment points for attachment to a mower having a three-point hitch; (right wheel removed for clarity)

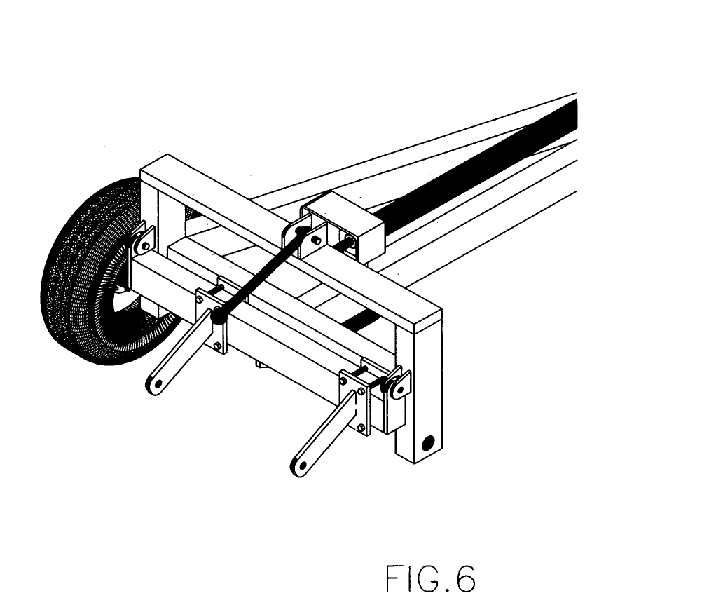

### DETAILED DESCRIPTION OF THE INVENTION

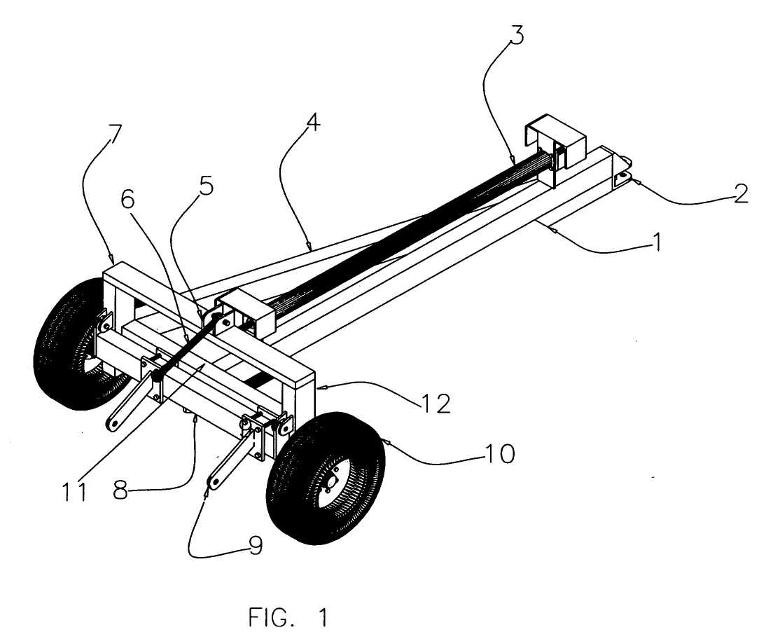

As can be seen from the enclosed drawings, (FIG. 1) the invention is comprised of a tow bar (1) welded to a cross bar (11). These are strengthened by the connecting bar (4). Vertical bars (12) and a top cross bar (7) complete the main frame.

Flotation type tires (10) on standard 6 holes agriculture hub and axle assemblies are mounted to the vertical bars (12) by the accepted method of a tube receiver and bolted in axle. This allows easy replacement in the event of axle failure.

The three-point mounting system (9) is unique in the fact that by the use of the mounting bolts and the interchangeable lift arms with multiple mounting holes there are multiple mounting heights available to comply with mower requirements.

All three-point mounting positions comply with recommended distances from PTO (3) to mounting holes thereby permitting easy hook up of the mower's drive lines.

The ballasted (weighted) tow bar, (1) cross bar (8) and connecting bar (4) give stability for transport and use of most mowers.

As an expert can well understand, various different solutions can be attached to the cart described always remaining in the characteristics of the invention.

These and other solutions are all possible without exiting from the invention.

What is claimed is:

1. An agricultural implement trailer for supporting most brands of disc mowers for field usage and transport, said trailer comprising:
(a) a trailer body including a trailer frame and wheels supporting said trailer frame;
(b) a hitch member comprising attachment points for connection to a disc mower;
(c) an extended PTO shaft for mower operation.

2. The implement trailer as recited in claim 1, in which:
(d) said linkage assembly comprises upper and lower link structures, each of said upper and lower link structures including proximal and distal ends defining said proximal and distal ends of said linkage assembly.

3. The implement trailer as recited in claim 2, in which:
(e) a hydraulic cylinder is operatively connected to said hitch member for raising said hitch member and attached implement, said hydraulic cylinder extending from an attachment point on said lower link structure to an attachment on said hitch member.

4. The implement trailer as recited in claim 3, in which:
(f) said upper and lower link structures are of generally equal length and define a parallelogram structure.

5. The implement trailer as recited in claim 4, in which:
(g) said upper and lower length structures are pivot able upward during movement of said hitch member from a lowered position to a raised position.

6. The implement trailer as recited in claim 5, in which:
(h) said attachment points comprise connections for attachment to and detachment from a three-point hitch on a mower.

7. The implement trailer recited in claim 6, in which:
(i) said PTO assembly includes front and rear bearing support structures wherein said PTO shaft transmits power from tractor PTO to rear mounted mower.
